(19) United States
(12) Patent Application Publication
(10) Pub. No.: US 2023/0305617 A1
(43) Pub. Date: Sep. 28, 2023

(54) DYNAMIC POWER MODES FOR BOOT-UP PROCEDURES

(71) Applicant: Micron Technology, Inc., Boise, ID (US)

(72) Inventors: Luca Porzio, Casalnuovo (NA) (IT); Christian M. Gyllenskog, Meridian, ID (US); Giuseppe Cariello, Boise, ID (US); Marco Onorato, Villasanta (MB) (IT); Roberto IZZI, Caserta (IT); Stephen Hanna, Fort Collins, CO (US); Jonathan S. Parry, Boise, ID (US); Reshmi Basu, Boise, ID (US); Nadav Grosz, Broomfield, CO (US); David Aaron Palmer, Boise, ID (US)

(21) Appl. No.: 18/096,288

(22) Filed: Jan. 12, 2023

Related U.S. Application Data
(60) Provisional application No. 63/314,002, filed on Feb. 25, 2022.

(51) Int. Cl. G06F 1/3234; G06F 9/4401; G06F 1/324

(52) U.S. Cl. CPC G06F 1/3275; G06F 1/324; G06F 9/4411

(57) ABSTRACT

Methods, systems, and devices for dynamic power modes for boot-up procedures are described. A memory system may initiate a boot-up procedure according to a predefined first power mode that is associated with a first power consumption. The memory system may then determine whether to perform the boot-up procedure according to the first power mode or a second power mode associated with a different second power consumption. In cases that the memory system receives an indication of the second power mode from the host system, the memory system may perform the boot-up procedure according to the second power mode. Additionally, in cases that the memory system does not receive an indication of the second power mode from the host system, the memory system may perform the boot-up procedure according to the first power mode.

### CROSS REFERENCE

The present Application for Patent claims priority to U.S. Provisional Pat. Application No. 63/314,002 by Porzio et al., entitled “DYNAMIC POWER MODES FOR BOOT-UP PROCEDURES”, filed Feb. 25, 2022, which is assigned to the assignee hereof, and which is expressly incorporated by reference in its entirety herein.

### FIELD OF TECHNOLOGY

The following relates to one or more systems for memory, including dynamic power modes for boot-up procedures.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports dynamic power modes for boot-up procedures in accordance with examples as disclosed herein.

FIGS. 2 and 3 illustrate examples of process flows that support dynamic power modes for boot-up procedures in accordance with examples as disclosed herein.

FIG. 4 shows a block diagram of a memory system that supports dynamic power modes for boot-up procedures in accordance with examples as disclosed herein.

FIG. 5 shows a block diagram of a host system that supports dynamic power modes for boot-up procedures in accordance with examples as disclosed herein.

FIGS. 6 and 7 show flowcharts illustrating a method or methods that support dynamic power modes for boot-up procedures in accordance with examples as disclosed herein.

### DETAILED DESCRIPTION

Many battery-powered devices (e.g., cell phones, laptops) may include one or more memory systems to store information at the device. Frequently, a battery of the battery-powered device may not be fully charged (e.g., if the battery level is below a threshold) if the device is powered on by a user. In such cases, a host system of the battery-power device may initiate a boot-up procedure at the one or more memory systems. However, the lower-power state of the device may impede the boot-up procedure at a memory system. For example, in some cases, the current provided by the battery of the battery-powered device may not be sufficient to perform the boot-up procedure at the memory system. In such examples, the memory system may attempt to perform the boot-up procedure, but may crash due to lack of current. In some cases, the host system may repeatedly initiate boot-up procedures at the memory system, which may repeatedly the attempt to perform the boot-up procedures, but may crash, thus entering a boot-up failure loop.

Accordingly, the techniques as described herein provide dynamic power modes for boot-up procedures at a memory system. Specifically, an initial power mode for boot-up procedures at the memory system may be configured at the memory system during a provisioning procedure of the memory system (e.g., during an initial configuration of the memory system by a user). Additionally, after initiating a boot-up procedure of the memory system (e.g., according to the initial power mode), the host system may indicate for the memory system to perform the boot-up procedure according to a different power mode. In either case, in instances that a lower-power state of the device may impede the boot-up procedure at the memory system, the memory system may perform some or all of the boot-up procedure in a lower-power mode, which may in tum prevent the memory system from entering the boot-up failure cycle. In one case, the memory system may be configured with an initial power mode for boot-up procedures that is a lower-power mode. Here, the memory system may initiate the boot-up procedure in the lower-power mode. In another case, the memory system may be configured with an initial power mode for boot-up procedures that is a higher-power mode. Here, the host system may indicate for the memory system to switch to performing the boot-up procedure in the lower-power mode in cases that a lower-power state of the device may impede the boot-up procedure at the memory system.

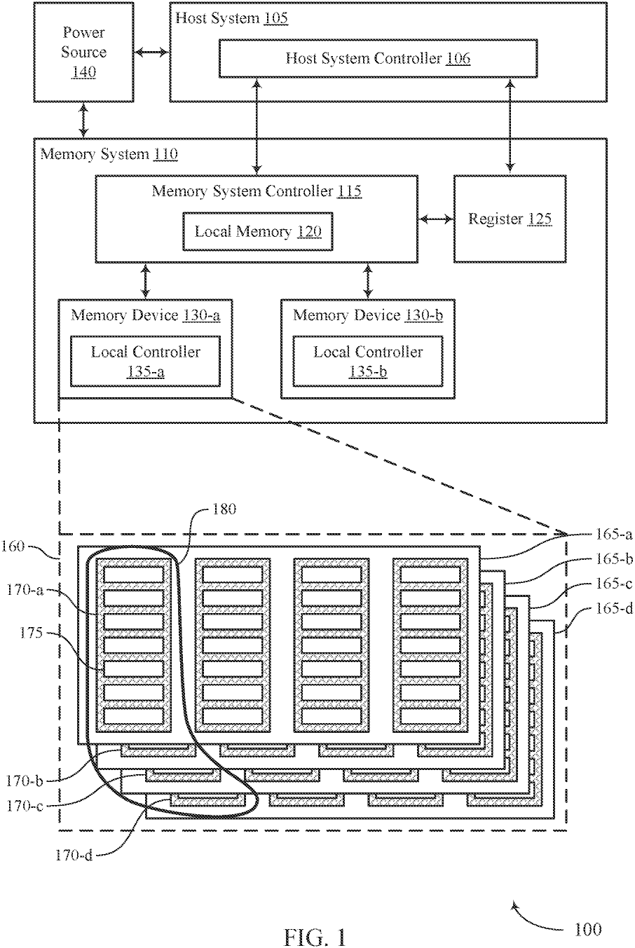

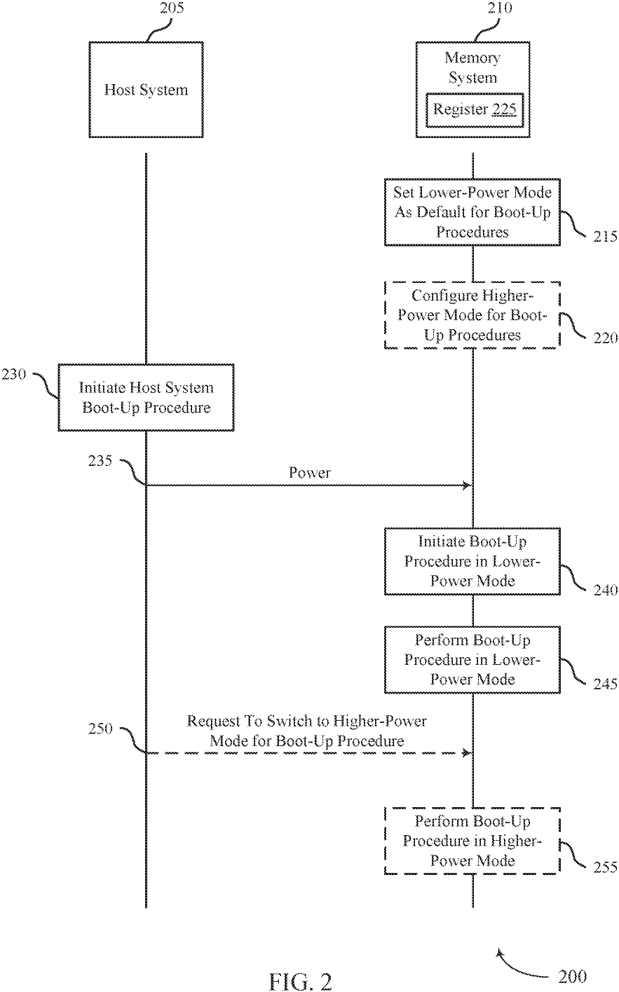

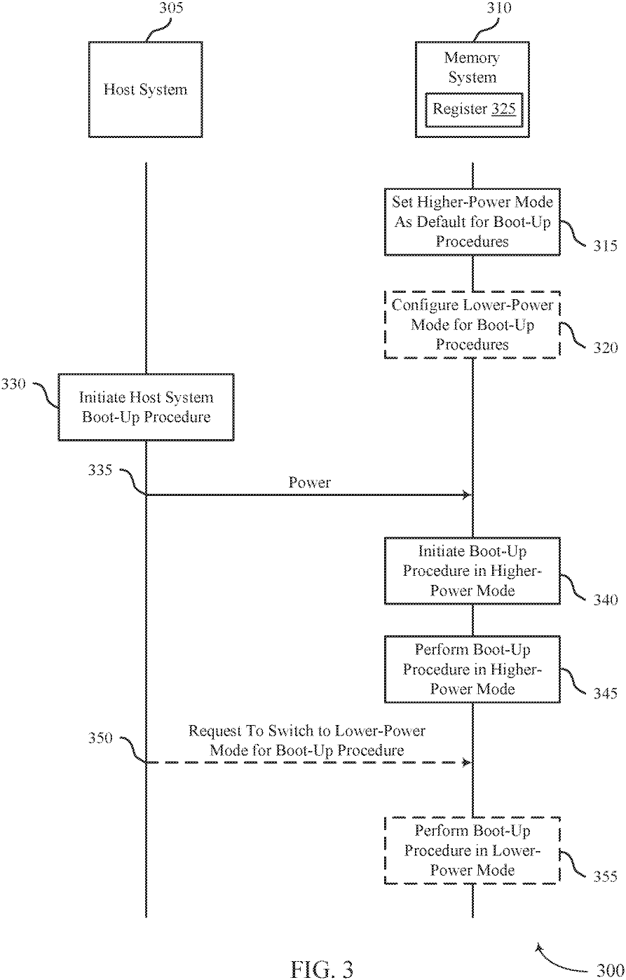

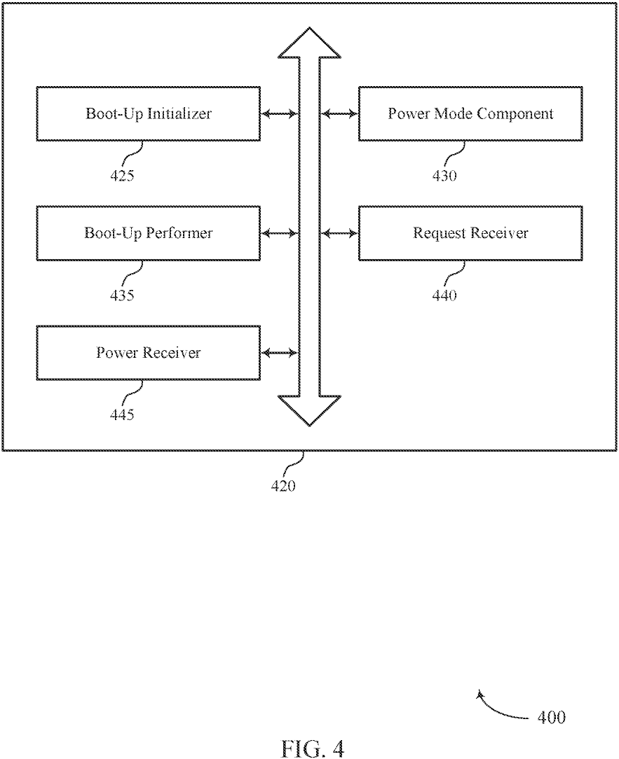

Features of the disclosure are initially described in the context of a system with reference to FIG. 1. Features of the disclosure are described in the context of process flows with reference to FIGS. 2 and 3. These and other features of the disclosure are further illustrated by and described in the context of apparatus diagrams and flowcharts that relate to dynamic power modes for boot-up procedures with reference to FIGS. 4-7.

FIG. 1 illustrates an example of a system 100 that supports dynamic power modes for boot-up procedures in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115, one or more registers 125, and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally or alternatively include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally or alternatively rely upon an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magnetic RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a memory die 160. For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multilevel cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may take place within different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be rewritten with new data. Thus, for example, a used page 175 may, in some cases, not be updated until the entire block 170 that includes the page 175 has been erased.

The system 100 may include a power source 140. In some cases, the power source 140 may be a battery and the system 100 may be an example of a battery-powered device, such as a phone, laptop, tablet, or other device. Additionally, or alternatively, the power source 140 may be associated with a limited current (e.g., 500 mA). In either case, a user may power-on the system 100 at a time that the power source 140 is supplying less current than the host system 105 and memory system 110 use during some boot-up procedures. For example, one or more host systems 105 at the system 100 may perform boot-up procedures at the host system 105, which may include sending commands to associated memory systems 110 to perform boot-up procedures of the memory systems 110. In some cases, a memory system 110 may fail to boot-up due to a lack of sufficient current to perform the boot-up procedure. In some cases, upon a failed boot-up at the memory system 110, the host system controller 106 may resend the boot-up command to the memory system 110, thus commanding the memory system 110 to try booting-up again. If the low-charge condition (e.g., the power source 140 supplying less power to the memory system 110 than the memory system 110 uses to perform the boot-up procedure) persists, the second boot-up procedure may fail as well. After the next failure, the host system 105 may again send a boot-up command, and the system 100 may enter a boot-up failure loop for the memory system 110.

In the example of system 100, the memory system 110 may be configured (e.g., during a provisioning procedure of the memory system 110) to initiate boot-up procedures at the memory system 110 according to a lower-power mode. Additionally, or alternatively, the host system 105 may dynamically indicate for the memory system 110 to switch to performing a boot-up procedure of the memory system 110 according to a lower power mode. Thus, the memory system 110 may perform some or all of a boot-up procedure according to a lower-power mode which may decrease a likelihood of entering a boot-up failure loop.

The memory system 110 may initiate a boot-up procedure according to a power mode that is indicated by the register 125. For example, the register 125 may store a value indicating one of multiple possible power modes for a boot-up procedure, where each power mode is associated with a different power consumption (e.g., a different maximum current drawn by the memory system 110). That is, the register 125 may store a first value indicating a first power mode for boot-up procedures or a second value indicating a different second power mode for boot-up procedures. If the host system 105 initiates a boot-up procedure of the memory system 110, the memory system 110 may initiate the boot-up procedure according to the power mode indicated by the register 125.

A default or initial value of the register 125 may be set at the memory system 110 during a provisioning of the memory system 110. For example, prior to coupling the memory system 110 with the host system 105 (e.g., during or soon after a manufacturing of the memory system 110), a user of the system 100 may set one or more parameters (e.g., partitioning, a default or initial power mode for boot-up procedures) for the memory system 110. To define the default or initial power mode for boot-up procedures of the memory system 110 during the provisioning procedure, the user may set the register 125 (e.g., a bCurrDevState register 125) to a value indicating the default or initial power mode. Then, as part of the provisioning procedure, the user may set another register (e.g., a bConfigDescrLock register), which may lock the default or initial power mode for boot-up procedures indicated by the value of the register 125 if the other register (e.g., the bConfigDescrLock register) is set. Even in cases that a value stored by the register 125 is changed after the locking (e.g., after setting the bConfigDescrLock register), by locking the register 125 while the register 125 is storing the value indicating the default or initial power mode for boot-up procedures, the memory system 110 will reset the register 125 to the value indicating the default or initial power mode at reset events. A reset event may include, for example, powering on the system 100, a reset request indicated by a hardware reset pin of the system 100, or a local reset request within the system 100 (e.g., from the host system 105).

In some instances, a user may set the value of the register 125 during the provisioning procedure to a value indicating a lower-power mode for boot-up procedures, where the memory system 110 consumes less current during the boot-up procedure (e.g., less than 500 mA) when compared to a higher-power mode for boot-up procedures. For example, in cases that the system 100 may include a power source 140 associated with a current supply that may be less than the current used by the memory system 110 during a boot-up procedure performed according to the higher-power mode, the user may set the register 125 to a value indicating to initiate boot-up procedures according to a lower-power mode.

The host system 105 may update the value stored by the register 125 after the provisioning procedure. That is, after the provisioning procedure, the host system 105 may request for the memory system 110 to perform a boot-up procedure according to a different power mode than defined during the provisioning procedure. For example, in cases that the memory system 110 is configured during the provisioning procedure to initiate boot-up procedures according to a lower-power mode, the host system 105 may set the register 125 to a value indicating a different higher-power mode. Here, the memory system 110 may dynamically switch from performing the boot-up procedure according to the lower-power mode to the higher-power mode. In another example, in cases that the memory system 110 is configured during the provisioning procedure to initiate boot-up procedures according to a higher-power mode, the host system 105 may set the register 125 to a value indicating a different lower-power mode. Here, the memory system 110 may dynamically switch from performing the boot-up procedure according to higher-power system to the lower-power mode.

The system 100 may include any quantity of non-transitory computer readable media that support dynamic power modes for boot-up procedures. For example, the host system 105, the memory system controller 115, or a memory device 130 (e.g., a local controller 135) may include or otherwise may access one or more non-transitory computer readable media storing instructions (e.g., firmware) for performing the functions ascribed herein to the host system 105, memory system controller 115, or memory device 130. For example, such instructions, if executed by the host system 105 (e.g., by the host system controller 106), by the memory system controller 115, or by a memory device 130 (e.g., by a local controller 135), may cause the host system 105, memory system controller 115, or memory device 130 to perform one or more associated functions as described herein.

FIG. 2 illustrates an example of a process flow 200 that supports dynamic power modes for boot-up procedures in accordance with examples as disclosed herein. The process flow 200 may include aspects of a system 100 as described with reference to FIG. 1. For example, the host system 205, the memory system 210, and the register 225 may be examples of the host system 105, the memory system 110, and the register 125, respectively. Aspects of the process flow 200 may be implemented by a controller, among other components. Additionally, or alternatively, aspects of the process flow 200 may be implemented as instructions stored in memory (e.g., firmware stored in a memory coupled with the memory system 110, the memory devices 130). For example, the instructions, when executed by a controller (e.g., the memory system controller 115, a local controller 135), may cause the controller to perform the operations of the process flow 200.

At 215, a lower-power mode may be set as a default power mode for boot-up procedures of the memory system 210. That is, the memory system 210 may undergo a provisioning procedure, where a register 225 (e.g., a bCurrDevState register) at the memory system 210 may be set (e.g., by a user, by the host system 205) to a value indicating for the lower-power mode be the initial power mode for boot-up procedures at the memory system 210. Additionally, another register of the memory system 210 (e.g., a bConfigDescrLock) may be set to lock the value of the register of the memory system 210 storing the value indicating for the lower-power mode to be the initial power mode for boot-up procedures. By locking the value of the register 225 of the memory system 210 after storing the value indicating the lower-power mode in the register 225, the memory system 210 may set the register 225 to the value indicating for the lower-power mode to be the initial power mode for boot-up procedures at each reset event (e.g., even in cases that the register has been updated to store a different value prior to the reset event). In some cases, the provisioning procedure may end in direct response to setting the bConfigDescrLock register to lock the values stored in one or more other registers at the memory system 210.

At 220, a higher-power mode may be configured at the memory system 210. In one example, the higher-power mode may be configured during the provisioning procedure or during a manufacturing of the memory system 210. For example, another register of the memory system 210 may be set to a value indicating a configuration for the higher-power mode. In some other instances, the host system 205 may indicate the configuration for the higher-power mode to the memory system 210 dynamically. For example, the host system 205 may set the register of the memory system 210 to a value indicating the configuration for the higher-power mode (e.g., after the provisioning procedure).

At 230, a boot-up procedure of the host system 205 may be initiated. For example, a user may power on a system including the host system 205 and the memory system 210 and the host system 205 may initiate a boot-up procedure of the host system 205 in response. In some other cases, the host system 205 may initiate a boot-up procedure in response to another trigger (e.g., a reset of the host system 205).

At 235, power may be supplied to the memory system 210 by the host system 205. For example, the host system 205 may supply power to the memory system 210 as part of the boot-up procedure of the host system 205.

At 240, a boot-up procedure of the memory system 210 may be initiated. For example, the memory system 210 may initiate the boot-up procedure according to the lower-power mode in response to receiving power from the host system 205. In some cases, the memory system 210 may initiate the boot-up procedure according to the lower-power mode based on the register 225 of the memory system 210 storing the value indicating the lower-power mode (e.g., the value of the register 225 set during the provisioning procedure). Initiating the boot-up procedure of the memory system 210 according to the lower-power mode may include initiating a boot-up procedure associated with a first power consumption (e.g., a low peak current power consumption of less than a current threshold such as 500 mA).

At 245, at least a portion of the boot-up procedure of the memory system 210 may be performed according to the lower-power mode. That is, the memory system 210 may perform at least a portion of the boot-up procedure initiated at 240 according to the lower-power mode indicated by the register 225. If performing the boot-up procedure according to the lower-power mode, the memory system 210 may consume less than a threshold amount of power (e.g., draining less than 500 mA, consuming less than 1.1 watts of total power).

At 250, a request to switch to a higher-power mode for the boot-up procedure of the memory system 210 may be transmitted by the host system 205 to the memory system 210. The host system 205 may determine whether to switch to the higher-power mode for the boot-up procedure of the memory system 210 based on an amount of power supplied to the memory system 210 (e.g., at 235). For example, in some cases the host system 205 may determine that the power level supplied to the memory system 210 is less than a power consumption of the memory system 210 if performing a boot-up procedure according to the higher-power mode. Here, the host system 205 may refrain from requesting for the memory system 210 to switch to the higher-power mode for the boot-up procedure of the memory system 210. Additionally, in some cases the host system 205 may determine that the power level supplied to the memory system 210 is greater than the power consumption of the memory system 210 if performing a boot-up procedure according to the higher-power mode. Here, the host system 205 may request for the memory system 210 to switch to the higher-power mode for the boot-up procedure of the memory system 210.

The host system 205 may request for the memory system 210 to switch to the higher-power mode for the boot-up procedure by setting the register 225 to a value indicating the higher-power mode. Here, the memory system 210 may determine whether to perform a remaining portion of the boot-up procedure according to the initial or predefined lower-power mode indicated by the register 225 upon the memory system 210 receiving power at 235 or to perform the remaining portion of the boot-up procedure according to a different higher-power mode based on the whether the register 225 is storing a value indicating the lower-power mode or the higher-power mode. In cases that the register 225 is storing the value indicating the lower-power mode, the memory system 210 may continue performing the boot-up procedure according to the lower-power mode associated with the decreased power consumption. Additionally, in cases that the register 225 is storing a value indicating the higher-power mode (e.g., if the host system 205 requests for the memory system 210 to switch to the higher-power mode at 250), the memory system 210 may switch to performing the boot-up procedure according to the higher-power mode associated with an increased power consumption.

At 255, a portion of the boot-up procedure may optionally be executed according to the higher-power mode (e.g., in cases that the host system 205 indicates for the memory system 210 to switch to the higher-power mode at 250). In some other cases, the memory system 210 may determine to switch to the higher-power mode without receiving the request from the host system 205 at 250. For example, the memory system 210 may determine that the power received from the host system 205 (e.g., at 235) exceeds the power consumption associated with the higher-power mode. Here, the memory system 210 may determine to switch to performing the boot-up procedure according to the higher-power mode independently of receiving an indication to switch from the host system 205.

To switch from performing the boot-up procedure according to the lower-power mode to the higher-power mode, the memory system 210 may adjust one or more parameters. For example, the memory system 210 may adjust a power consumption from a low peak current power consumption to a higher peak current power consumption. That is, if performing the boot-up procedure according to the lower-power mode, the memory system 210 may drain less than a threshold current (e.g., 500 mA) and consume less than a threshold amount of total power (e.g., 1.1 Watts). Here, if performing the boot-up procedure according to the higher-power mode, the memory system 210 may drain more than the threshold current or consume more than the threshold amount of total power.

In some other examples, if switching to perform the boot-up procedure according to the higher-power mode, the memory system 210 may increase a clock rate of the memory system 210. For example, the memory system 210 may increase an internal controller frequency if switching from the lower-power mode to the higher-power mode for the boot-up procedure. Additionally, the memory system 210 may supply power to additional components or memory devices (e.g., such as memory devices 130) of the memory system 210 if switching from the lower-power mode to the higher-power mode. That is, the memory system 210 may supply power to a subset of components or memory devices of the memory system 210 (e.g., less than all of the components or memory devices of the memory system 210) if performing the boot-up procedure according to the lower-power mode. Here, the memory system 210 may supply power to additional components or memory components based on switching to performing the boot-up procedure according to the higher-power mode. Additionally, the memory system 210 may increase a quantity of dies or planes (e.g., of memory devices of the memory system 210) receiving power at the same time (e.g., a quantity of parallelisms) in response to switching from performing the boot-up procedure according to the lower-power mode to the higher-power mode.

Additionally, the memory system 210 may execute additional operations not performed during the boot-up procedure if performing the boot-up procedure according to the lower-power mode. For example, some operations may consume more than a threshold (e.g., operations that yield high current absorption). If performing the boot-up procedure according to the lower-power mode, the memory system 210 may refrain from executing operations that consume more than the threshold. In response to switching to performing the boot-up procedure according to the higher-power mode, the memory system 210 may execute operations that consume more than the threshold.

FIG. 3 illustrates an example of a process flow 300 that supports dynamic power modes for boot-up procedures in accordance with examples as disclosed herein. The process flow 300 may include aspects of FIGS. 1 and 2. For example, the host system 305, the memory system 310, and register 325 may be examples of the host system, memory system, and register as described with reference to FIGS. 1 and 2, respectively. Aspects of the process flow 300 may be implemented by a controller, among other components. Additionally, or alternatively, aspects of the process flow 300 may be implemented as instructions stored in memory (e.g., firmware stored in a memory coupled with the memory system 110, the memory devices 130). For example, the instructions, when executed by a controller (e.g., the memory system controller 115, a local controller 135), may cause the controller to perform the operations of the process flow 300.

At 315, a higher-power mode may be set as a default power mode for boot-up procedures of the memory system 310. That is, the memory system 310 may undergo a provisioning procedure, where a register 325 (e.g., a bCurrDevState register) at the memory system 310 may be set (e.g., by a user, by the host system 305) to a value indicating for the higher-power mode be the initial power mode for boot-up procedures at the memory system 310. Additionally, another register of the memory system 310 (e.g., a bConfigDescrLock) may be set to lock the value of the register of the memory system 310 storing the value indicating for the higher-power mode to be the initial power mode for boot-up procedures. By locking the value of the register 325 of the memory system 310 after storing the value indicating the higher-power mode in the register 325, the memory system 310 may set the register 325 to the value indicating for the higher-power mode to be the initial power mode for boot-up procedures at each reset event (e.g., even in cases that the register has been updated to store a different value prior to the reset event). In some cases, the provisioning procedure may end in direct response to setting the bConfigDescrLock register to lock the values stored in one or more other registers at the memory system 310.

At 320, a lower-power mode may be configured at the memory system 310. In one example, the lower-power mode may be configured during the provisioning procedure or during a manufacturing of the memory system 310. For example, another register of the memory system 310 may be set to a value indicating a configuration for the lower-power mode. In some other instances, the host system 305 may indicate the configuration for the lower-power mode to the memory system 310 dynamically. For example, the host system 305 may set the register of the memory system 310 to a value indicating the configuration for the lower-power mode (e.g., after the provisioning procedure).

At 330, a boot-up procedure of the host system 305 may be initiated. For example, a user may power on a system including the host system 305 and the memory system 310 and the host system 305 may initiate a boot-up procedure of the host system 305 in response. In some other cases, the host system 305 may initiate a boot-up procedure in response to another trigger (e.g., a reset of the host system 305).

At 335, power may be supplied to the memory system 310 by the host system 305. For example, the host system 305 may supply power to the memory system 310 as part of the boot-up procedure of the host system 305.

At 340, a boot-up procedure of the memory system 310 may be initiated. For example, the memory system 310 may initiate the boot-up procedure according to the higher-power mode in response to receiving power from the host system 305. In some cases, the memory system 310 may initiate the boot-up procedure according to the higher-power mode based on the register 325 of the memory system 310 storing the value indicating the higher-power mode (e.g., the value of the register 325 set during the provisioning procedure). Initiating the boot-up procedure of the memory system 310 according to the higher-power mode may include initiating a boot-up procedure associated with a first power consumption.

At 345, at least a portion of the boot-up procedure of the memory system 310 may be performed according to the higher-power mode. That is, the memory system 310 may perform at least a portion of the boot-up procedure initiated at 340 according to the higher-power mode indicated by the register 325.

At 350, a request to switch to a lower-power mode for the boot-up procedure of the memory system 310 may be transmitted by the host system 305 to the memory system 310. The host system 305 may determine whether to switch to the lower-power mode for the boot-up procedure of the memory system 310 based on an amount of power supplied to the memory system 310 (e.g., at 335). For example, in some cases the host system 305 may determine that the power level supplied to the memory system 310 is greater than a power consumption of the memory system 310 if performing a boot-up procedure according to the higher-power mode. Here, the host system 305 may refrain from requesting for the memory system 310 to switch to the lower-power mode for the boot-up procedure of the memory system 310. Additionally, in some cases the host system 305 may determine that the power level supplied to the memory system 310 is less than the power consumption of the memory system 310 if performing a boot-up procedure according to the higher-power mode. Here, the host system 305 may request for the memory system 310 to switch to the lower-power mode for the boot-up procedure of the memory system 310 at 350.

The host system 305 may request for the memory system 310 to switch to the lower-power mode for the boot-up procedure by setting the register 325 to a value indicating the lower-power mode. Here, the memory system 310 may determine whether to perform a remaining portion of the boot-up procedure according to the initial or predefined higher-power mode indicated by the register 325 upon the memory system 310 receiving power at 335 or to perform the remaining portion of the boot-up procedure according to a different lower-power mode based on the whether the register 325 is storing a value indicating the higher-power mode or the lower-power mode. In cases that the register 325 is storing the value indicating the higher-power mode, the memory system 310 may continue performing the boot-up procedure according to the higher-power mode associated with an increased power consumption. Additionally, in cases that the register 325 is storing a value indicating the lower-power mode (e.g., if the host system 305 requests for the memory system 310 to switch to the lower-power mode at 350), the memory system 310 may switch to performing the boot-up procedure according to the lower-power mode associated with a decreased power consumption.

At 355, a portion of the boot-up procedure may optionally be executed according to the lower-power mode (e.g., in cases that the host system 305 indicates for the memory system 310 to switch to the lower-power mode at 350). In some other cases, the memory system 310 may determine to switch to the lower-power mode without receiving the request from the host system 305 at 350. For example, the memory system 310 may determine that the power received from the host system 305 (e.g., at 335) is less than the power consumption associated with the higher-power mode. Here, the memory system 310 may determine to switch to performing the boot-up procedure according to the lower-power mode independently of receiving an indication to switch from the host system 305.

To switch from performing the boot-up procedure according to the higher-power mode to the lower-power mode, the memory system 310 may adjust one or more parameters. For example, the memory system 310 may adjust a power consumption from a higher peak current power consumption to a lower peak current power consumption. That is, if performing the boot-up procedure according to the higher-power mode, the memory system 310 may drain more than a threshold current (e.g., 500 mA) and consume more than a threshold amount of total power (e.g., 1.1 Watts). If performing the boot-up procedure according to the lower-power mode, the memory system 310 may drain less than the threshold current or consume less than the threshold amount of total power.

In some other examples, if switching to perform the boot-up procedure according to the lower-power mode, the memory system 310 may decrease a clock rate of the memory system 310. For example, the memory system 310 may decrease an internal controller frequency if switching from the higher-power mode to the lower-power mode for the boot-up procedure. Additionally, the memory system 310 may supply power to less components or memory devices (e.g., such as memory devices 130) of the memory system 310 if switching from the higher-power mode to the lower-power mode. That is, the memory system 310 may supply power a first quantity of components or memory devices of the memory system 310 if performing the boot-up procedure according to the higher-power mode. Additionally, the memory system 310 may supply power to a second quantity of components or memory components that is less than the first quantity based on switching to performing the boot-up procedure according to the lower-power mode. Additionally, the memory system 310 may decrease a quantity of dies or planes (e.g., of memory devices of the memory system 310) receiving power at the same time (e.g., a quantity of parallelisms) in response to switching from performing the boot-up procedure according to the higher-power mode to the lower-power mode.

Additionally, the memory system 310 may refrain from executing some operations during the boot-up procedure if performing the boot-up procedure according to the lower-power mode. For example, some operations may consume more than a threshold (e.g., operations that yield high current absorption). If performing the boot-up procedure according to the higher-power mode, the memory system 310 may execute operations that consume more than the threshold, but if performing the boot-up procedure according to the lower-power mode, the memory system 310 may refrain from executing operations that consume more than the threshold.

FIG. 4 shows a block diagram 400 of a memory system 420 that supports dynamic power modes for boot-up procedures in accordance with examples as disclosed herein. The memory system 420 may be an example of aspects of a memory system as described with reference to FIGS. 1 through 3. The memory system 420, or various components thereof, may be an example of means for performing various aspects of dynamic power modes for boot-up procedures as described herein. For example, the memory system 420 may include a boot-up initializer 425, a power mode component 430, a boot-up performer 435, a request receiver 440, a power receiver 445, or any combination thereof. Each of these components may communicate, directly or indirectly, with one another (e.g., via one or more buses).

The boot-up initializer 425 may be configured as or otherwise support a means for initiating a boot-up procedure of a memory system according to a first power mode associated with a first power consumption. The power mode component 430 may be configured as or otherwise support a means for determining, based at least in part on the initiating, whether to perform the boot-up procedure according to the first power mode or a second power mode associated with a second power consumption different than the first power consumption. The boot-up performer 435 may be configured as or otherwise support a means for performing the boot-up procedure according to the second power mode based at least in part on determining to perform the boot-up procedure according to the second power mode.

In some examples, the request receiver 440 may be configured as or otherwise support a means for receiving, from a host system, a request to perform the boot-up procedure according to the second power mode, where determining to perform the boot-up procedure according to the second power mode is based at least in part on receiving the request.

In some examples, to support receiving the request, the request receiver 440 may be configured as or otherwise support a means for reading a value of a register of the memory system, the value indicating whether to perform the boot-up procedure according to the first power mode or the second power mode.

In some examples, the second power consumption is greater than the first power consumption.

In some examples, performing the boot-up procedure according to the first power mode includes operating the memory system according to a first clock rate. In some examples, performing the boot-up procedure according to the second power mode includes operating the memory system according to a second clock rate that is faster than the first clock rate.

In some examples, performing the boot-up procedure according to the first power mode includes supplying power to a first quantity of components of the memory system. In some examples, performing the boot-up procedure according to the second power mode includes supplying power to a second quantity of components of the memory system that is greater than the first quantity.

In some examples, performing the boot-up procedure according to the first power mode includes supplying power to a first quantity of memory devices of the memory system. In some examples, performing the boot-up procedure according to the second power mode includes supplying power to a second quantity of memory devices of the memory system that is greater than the first quantity.

In some examples, performing the boot-up procedure according to the first power mode includes. In some examples, executing one or more first operations based at least in part on the first operations being associated with power consumption below a threshold. In some examples, refraining from executing one or more second operations based at least in part on the second operations being associated with power consumption above the threshold. In some examples, performing the boot-up procedure according to the second power mode includes. In some examples, executing one or more first operations. In some examples, executing one or more second operations.

In some examples, the power receiver 445 may be configured as or otherwise support a means for receiving power at the memory system, where initiating the boot-up procedure is based at least in part on receiving the power.

In some examples, the power mode component 430 may be configured as or otherwise support a means for determining that the received power is greater than the first power consumption associated with the first power mode, where determining to perform the boot-up procedure according to the second power mode is based at least in part on the determining.

In some examples, initiating the boot-up procedure according to the first power mode is based at least in part on the first power mode being a preconfigured power mode for the boot-up procedure.

In some examples, the boot-up initializer 425 may be configured as or otherwise support a means for storing, in a register, a value indicating the first power mode. In some examples, the boot-up initializer 425 may be configured as or otherwise support a means for locking the register to store the value, where initiating the boot-up procedure according to the first power mode is based at least in part on the register being locked to store the value.

In some examples, the second power consumption is less than the first power consumption.

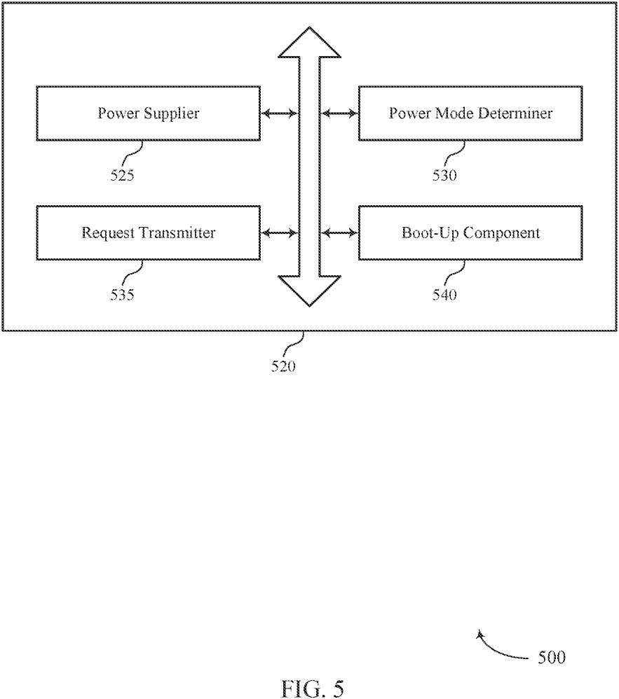

FIG. 5 shows a block diagram 500 of a host system 520 that supports dynamic power modes for boot-up procedures in accordance with examples as disclosed herein. The host system 520 may be an example of aspects of a host system as described with reference to FIGS. 1 through 3. The host system 520, or various components thereof, may be an example of means for performing various aspects of dynamic power modes for boot-up procedures as described herein. For example, the host system 520 may include a power supplier 525, a power mode determiner 530, a request transmitter 535, a boot-up component 540, or any combination thereof. Each of these components may communicate, directly or indirectly, with one another (e.g., via one or more buses).

The power supplier 525 may be configured as or otherwise support a means for supplying power to a memory system to initiate a boot-up procedure of the memory system according to a first power mode associated with a first power consumption. The power mode determiner 530 may be configured as or otherwise support a means for determining, based at least in part on supplying the power, whether to request the memory system to perform the boot-up procedure according to the first power mode or a second power mode associated with a second power consumption different than the first power consumption. The request transmitter 535 may be configured as or otherwise support a means for transmitting a request for the memory system to perform the boot-up procedure according to the second power mode based at least in part on the determining to request the memory system to perform the boot-up procedure according to the second power mode.

In some examples, to support transmitting the request, the request transmitter 535 may be configured as or otherwise support a means for writing a value indicating the second power mode to a register of the memory system.

In some examples, the second power consumption is greater than the first power consumption.

In some examples, the power mode determiner 530 may be configured as or otherwise support a means for determining that the power supplied to the memory system is greater than the first power consumption, where determining to request the memory system to perform the boot-up procedure according to the second power mode is based at least in part on the determining.

In some examples, the second power consumption is less than the first power consumption.

In some examples, the power mode determiner 530 may be configured as or otherwise support a means for determining that the power supplied to the memory system is less than the first power consumption, where determining to request the memory system to perform the boot-up procedure according to the second power mode is based at least in part on the determining.

In some examples, the boot-up component 540 may be configured as or otherwise support a means for initiating a second boot-up procedure of a host system, where supplying the power to the memory system to initiate the boot-up procedure is based at least in part on initiating the second boot-up procedure of the host system.

In some examples, the power mode determiner 530 may be configured as or otherwise support a means for determining a power level provided to the memory system for the boot-up procedure, where determining whether to request the memory system to perform the boot-up procedure according to the first power mode or the second power mode is based at least in part on determining the power level.

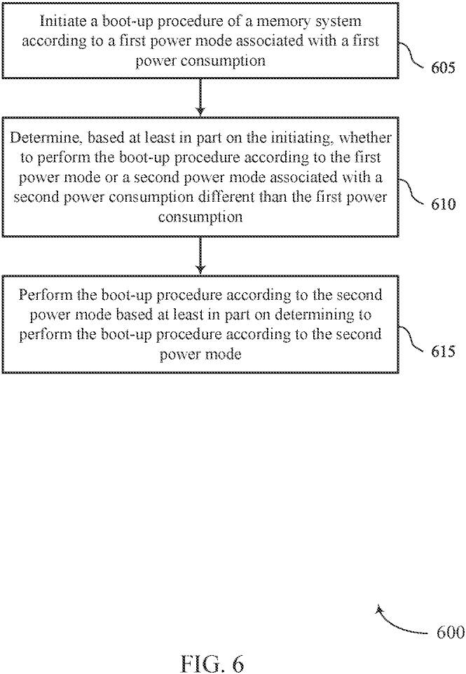

FIG. 6 shows a flowchart illustrating a method 600 that supports dynamic power modes for boot-up procedures in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include initiating a boot-up procedure of a memory system according to a first power mode associated with a first power consumption. The operations of 605 may be performed in accordance with examples as disclosed herein. In some examples, aspects of the operations of 605 may be performed by a boot-up initializer 425 as described with reference to FIG. 4.

At 610, the method may include determining, based at least in part on the initiating, whether to perform the boot-up procedure according to the first power mode or a second power mode associated with a second power consumption different than the first power consumption. The operations of 610 may be performed in accordance with examples as disclosed herein. In some examples, aspects of the operations of 610 may be performed by a power mode component 430 as described with reference to FIG. 4.

At 615, the method may include performing the boot-up procedure according to the second power mode based at least in part on determining to perform the boot-up procedure according to the second power mode. The operations of 615 may be performed in accordance with examples as disclosed herein. In some examples, aspects of the operations of 615 may be performed by a boot-up performer 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for initiating a boot-up procedure of a memory system according to a first power mode associated with a first power consumption; determining, based at least in part on the initiating, whether to perform the boot-up procedure according to the first power mode or a second power mode associated with a second power consumption different than the first power consumption; and performing the boot-up procedure according to the second power mode based at least in part on determining to perform the boot-up procedure according to the second power mode.

Aspect 2: The method, apparatus, or non-transitory computer-readable medium of aspect 1, further including operations, features, circuitry, logic, means, or instructions, or any combination thereof for receiving, from a host system, a request to perform the boot-up procedure according to the second power mode, where determining to perform the boot-up procedure according to the second power mode is based at least in part on receiving the request.

Aspect 3: The method, apparatus, or non-transitory computer-readable medium of aspect 2 where receiving the request, further includes operations, features, circuitry, logic, means, or instructions, or any combination thereof for reading a value of a register of the memory system, the value indicating whether to perform the boot-up procedure according to the first power mode or the second power mode.

Aspect 4: The method, apparatus, or non-transitory computer-readable medium of any of aspects 1 through 3 where the second power consumption is greater than the first power consumption.

Aspect 5: The method, apparatus, or non-transitory computer-readable medium of aspect 4 where performing the boot-up procedure according to the first power mode includes operating the memory system according to a first clock rate and performing the boot-up procedure according to the second power mode includes operating the memory system according to a second clock rate that is faster than the first clock rate.

Aspect 6: The method, apparatus, or non-transitory computer-readable medium of any of aspects 4 through 5 where performing the boot-up procedure according to the first power mode includes supplying power to a first quantity of components of the memory system and performing the boot-up procedure according to the second power mode includes supplying power to a second quantity of components of the memory system that is greater than the first quantity.

Aspect 7: The method, apparatus, or non-transitory computer-readable medium of any of aspects 4 through 6 where performing the boot-up procedure according to the first power mode includes supplying power to a first quantity of memory devices of the memory system and performing the boot-up procedure according to the second power mode includes supplying power to a second quantity of memory devices of the memory system that is greater than the first quantity.

Aspect 8: The method, apparatus, or non-transitory computer-readable medium of any of aspects 4 through 7 where performing the boot-up procedure according to the first power mode includes; executing one or more first operations based at least in part on the first operations being associated with power consumption below a threshold; refraining from executing one or more second operations based at least in part on the second operations being associated with power consumption above the threshold; performing the boot-up procedure according to the second power mode includes; executing one or more first operations; and executing one or more second operations.

Aspect 9: The method, apparatus, or non-transitory computer-readable medium of any of aspects 1 through 8, further including operations, features, circuitry, logic, means, or instructions, or any combination thereof for receiving power at the memory system, where initiating the boot-up procedure is based at least in part on receiving the power.

Aspect 10: The method, apparatus, or non-transitory computer-readable medium of aspect 9, further including operations, features, circuitry, logic, means, or instructions, or any combination thereof for determining that the received power is greater than the first power consumption associated with the first power mode, where determining to perform the boot-up procedure according to the second power mode is based at least in part on the determining.

Aspect 11: The method, apparatus, or non-transitory computer-readable medium of any of aspects 1 through 10 where initiating the boot-up procedure according to the first power mode is based at least in part on the first power mode being a preconfigured power mode for the boot-up procedure.

Aspect 12: The method, apparatus, or non-transitory computer-readable medium of any of aspects 1 through 11, further including operations, features, circuitry, logic, means, or instructions, or any combination thereof for storing, in a register, a value indicating the first power mode and locking the register to store the value, where initiating the boot-up procedure according to the first power mode is based at least in part on the register being locked to store the value.

Aspect 13: The method, apparatus, or non-transitory computer-readable medium of any of aspects 1 through 12 where the second power consumption is less than the first power consumption.

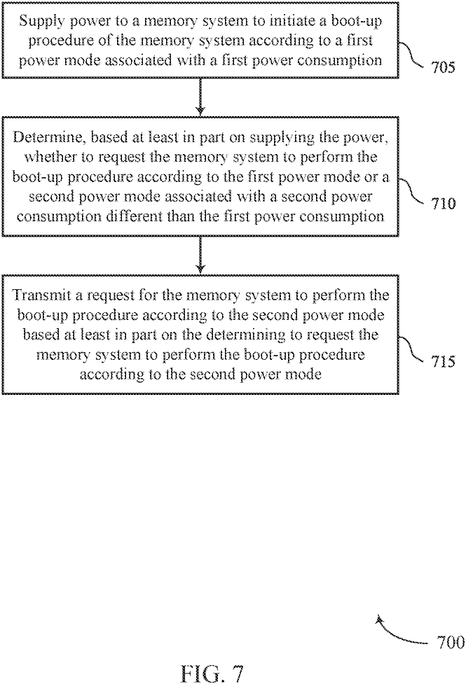

FIG. 7 shows a flowchart illustrating a method 700 that supports dynamic power modes for boot-up procedures in accordance with examples as disclosed herein. The operations of method 700 may be implemented by a host system or its components as described herein. For example, the operations of method 700 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 705, the method may include supplying power to a memory system to initiate a boot-up procedure of the memory system according to a first power mode associated with a first power consumption. The operations of 705 may be performed in accordance with examples as disclosed herein. In some examples, aspects of the operations of 705 may be performed by a power supplier 525 as described with reference to FIG. 5.

At 710, the method may include determining, based at least in part on supplying the power, whether to request the memory system to perform the boot-up procedure according to the first power mode or a second power mode associated with a second power consumption different than the first power consumption. The operations of 710 may be performed in accordance with examples as disclosed herein. In some examples, aspects of the operations of 710 may be performed by a power mode determiner 530 as described with reference to FIG. 5.

At 715, the method may include transmitting a request for the memory system to perform the boot-up procedure according to the second power mode based at least in part on the determining to request the memory system to perform the boot-up procedure according to the second power mode. The operations of 715 may be performed in accordance with examples as disclosed herein. In some examples, aspects of the operations of 715 may be performed by a request transmitter 535 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 14: A method, apparatus, or non-transitory computer-readable medium including operations, features, circuitry, logic, means, or instructions, or any combination thereof for supplying power to a memory system to initiate a boot-up procedure of the memory system according to a first power mode associated with a first power consumption; determining, based at least in part on supplying the power, whether to request the memory system to perform the boot-up procedure according to the first power mode or a second power mode associated with a second power consumption different than the first power consumption; and transmitting a request for the memory system to perform the boot-up procedure according to the second power mode based at least in part on the determining to request the memory system to perform the boot-up procedure according to the second power mode.

Aspect 15: The method, apparatus, or non-transitory computer-readable medium of aspect 14 where transmitting the request includes operations, features, circuitry, logic, means, or instructions, or any combination thereof for writing a value indicating the second power mode to a register of the memory system.

Aspect 16: The method, apparatus, or non-transitory computer-readable medium of any of aspects 14 through 15 where the second power consumption is greater than the first power consumption.

Aspect 17: The method, apparatus, or non-transitory computer-readable medium of any of aspects 14 through 16, further including operations, features, circuitry, logic, means, or instructions, or any combination thereof for determining that the power supplied to the memory system is greater than the first power consumption, where determining to request the memory system to perform the boot-up procedure according to the second power mode is based at least in part on the determining.

Aspect 18: The method, apparatus, or non-transitory computer-readable medium of any of aspects 14 through 17 where the second power consumption is less than the first power consumption.

Aspect 19: The method, apparatus, or non-transitory computer-readable medium of aspect 18, further including operations, features, circuitry, logic, means, or instructions, or any combination thereof for determining that the power supplied to the memory system is less than the first power consumption, where determining to request the memory system to perform the boot-up procedure according to the second power mode is based at least in part on the determining.

Aspect 20: The method, apparatus, or non-transitory computer-readable medium of any of aspects 14 through 19, further including operations, features, circuitry, logic, means, or instructions, or any combination thereof for initiating a second boot-up procedure of a host system, where supplying the power to the memory system to initiate the boot-up procedure is based at least in part on initiating the second boot-up procedure of the host system.

Aspect 21: The method, apparatus, or non-transitory computer-readable medium of any of aspects 14 through 20, further including operations, features, circuitry, logic, means, or instructions, or any combination thereof for determining a power level provided to the memory system for the boot-up procedure, where determining whether to request the memory system to perform the boot-up procedure according to the first power mode or the second power mode is based at least in part on determining the power level.

It should be noted that the methods described above describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally or alternatively (e.g., in an alternative example) be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory device; and
a controller coupled with the memory device and configured to cause the apparatus to:
initiate a boot-up procedure of a memory system according to a first power mode associated with a first power consumption;
determine, based at least in part on the initiating, whether to perform the boot-up procedure according to the first power mode or a second power mode associated with a second power consumption different than the first power consumption; and
perform the boot-up procedure according to the second power mode based at least in part on determining to perform the boot-up procedure according to the second power mode.

2. The apparatus of claim 1, wherein the controller is further configured to cause the apparatus to:
receive, from a host system, a request to perform the boot-up procedure according to the second power mode, wherein determining to perform the boot-up procedure according to the second power mode is based at least in part on receiving the request.

3. The apparatus of claim 2, wherein to receive the request the controller is further configured to cause the apparatus to:
read a value of a register of the memory system, the value indicating whether to perform the boot-up procedure according to the first power mode or the second power mode.

4. The apparatus of claim 1, wherein the second power consumption is greater than the first power consumption.

5. The apparatus of claim 4, wherein:
to perform the boot-up procedure according to the first power mode the controller is further configured to cause the apparatus to operate the memory system according to a first clock rate; and
to perform the boot-up procedure according to the second power mode the controller is further configured to cause the apparatus to operate the memory system according to a second clock rate that is faster than the first clock rate.

6. The apparatus of claim 4, wherein:
to perform the boot-up procedure according to the first power mode the controller is further configured to cause the apparatus to supply power to a first quantity of components of the memory system; and
to perform the boot-up procedure according to the second power mode the controller is further configured to cause the apparatus to supply power to a second quantity of components of the memory system that is greater than the first quantity.

7. The apparatus of claim 4, wherein:
to perform the boot-up procedure according to the first power mode the controller is further configured to cause the apparatus to supply power to a first quantity of memory devices of the memory system; and
to perform the boot-up procedure according to the second power mode the controller is further configured to cause the apparatus to supply power to a second quantity of memory devices of the memory system that is greater than the first quantity.

8. The apparatus of claim 4, wherein:
to perform the boot-up procedure according to the first power mode the controller is further configured to cause the apparatus to:
execute one or more first operations based at least in part on the first operations being associated with power consumption below a threshold, and
refrain from executing one or more second operations based at least in part on the second operations being associated with power consumption above the threshold; and
to perform the boot-up procedure according to the second power mode the controller is further configured to cause the apparatus to:
execute one or more first operations, and
execute one or more second operations.

9. The apparatus of claim 1, wherein the controller is further configured to cause the apparatus to:
receive power at the memory system, wherein initiating the boot-up procedure is based at least in part on receiving the power.

10. The apparatus of claim 9, wherein the controller is further configured to cause the apparatus to:
determine that the received power is greater than the first power consumption associated with the first power mode, wherein determining to perform the boot-up procedure according to the second power mode is based at least in part on the determining.

11. The apparatus of claim 1, wherein initiating the boot-up procedure according to the first power mode is based at least in part on the first power mode being a preconfigured power mode for the boot-up procedure.

12. The apparatus of claim 1, wherein the controller is further configured to cause the apparatus to:
store, in a register, a value indicating the first power mode; and
lock the register to store the value, wherein initiating the boot-up procedure according to the first power mode is based at least in part on the register being locked to store the value.

13. The apparatus of claim 1, wherein the second power consumption is less than the first power consumption.

14. An apparatus, comprising:
a controller configured to couple with a memory system, wherein the controller is configured to cause the apparatus to:
supply power to the memory system to initiate a boot-up procedure of the memory system according to a first power mode associated with a first power consumption;
determine, based at least in part on supplying the power, whether to request the memory system to perform the boot-up procedure according to the first power mode or a second power mode associated with a second power consumption different than the first power consumption; and
transmit a request for the memory system to perform the boot-up procedure according to the second power mode based at least in part on the determining to request the memory system to perform the boot-up procedure according to the second power mode.

15. The apparatus of claim 14, wherein to transmit the request the controller is further configured to cause the apparatus to:
write a value indicating the second power mode to a register of the memory system.

16. The apparatus of claim 14, wherein the controller is further configured to cause the apparatus to:
determine that the power supplied to the memory system is greater than the first power consumption, wherein determining to request the memory system to perform the boot-up procedure according to the second power mode is based at least in part on the determining.

17. The apparatus of claim 18, wherein the controller is further configured to cause the apparatus to:
determine that the power supplied to the memory system is less than the first power consumption, wherein determining to request the memory system to perform the boot-up procedure according to the second power mode is based at least in part on the determining.

18. The apparatus of claim 14, wherein the controller is further configured to cause the apparatus to:
initiate a second boot-up procedure of a host system, wherein supplying the power to the memory system to initiate the boot-up procedure is based at least in part on initiating the second boot-up procedure of the host system.

19. The apparatus of claim 14, wherein the controller is further configured to cause the apparatus to:
determine a power level provided to the memory system for the boot-up procedure, wherein determining whether to request the memory system to perform the boot-up procedure according to the first power mode or the second power mode is based at least in part on determining the power level.

20. A non-transitory computer-readable medium storing code comprising instructions which, when executed by a processor of an electronic device, cause the electronic device to:
initiate a boot-up procedure of a memory system according to a first power mode associated with a first power consumption;
determine, based at least in part on the initiating, whether to perform the boot-up procedure according to the first power mode or a second power mode associated with a second power consumption different than the first power consumption; and
perform the boot-up procedure according to the second power mode based at least in part on determining to perform the boot-up procedure according to the second power mode.
